(19) United States
(12) Patent Application Publication
(10) Pub. No.: US 2016/0179769 A1
(43) Pub. Date: Jun. 23, 2016

(54) All-in-One Website Generator System and Method with a Content-Sensitive Domain Suggestion Generator

(71) Applicants: Efraim Gershom, Overland Park, KS (US); Shaul Jolles, Kansas City, MO (US); Shay Yahalom, Beit Dagan, IL (US); Bar Isyomin, Tel Aviv (IL); Desiree Boxberger, Overland Park, KS (US)

(72) Inventors: Efraim Gershom, Overland Park, KS (US); Shaul Jolles, Kansas City, MO (US); Shay Yahalom, Beit Dagan, IL (US); Bar Isyomin, Tel Aviv (IL); Desiree Boxberger, Overland Park, KS (US)

(21) Appl. No.: 14/705,946

(22) Filed: May 6, 2015

Related U.S. Application Data
(60) Provisional application No. 62/095,544, filed on Dec. 22, 2014.

(51) Int. Cl. G06F 17/22; H04L 29/12; G06F 17/30; G06F 17/24

(52) U.S. Cl. CPC G06F 17/2247; G06F 17/248; H04L 61/1511; G06F 17/30345

(57) ABSTRACT

A dynamic, rapid website-generating system and method is detailed. The system is configured to expedite and simplify the website creation and hosting processes for the end user web-creator, while dynamically creating content based on the web-creator's online footprint via permitted, associated social networks. The system is configured to provide domain name suggestions to the web-creator based on data gathered from social networks, as well as based upon web-content crafted and/or uploaded to the website during construction. Domain is decided by user from a pool of available domains that have been suggested after the website is built, such that the domains suggested relate to the website content of the website that has been built. Domain setup and registration, hosting setup, name server/DNS setup, and uploading are all automated to streamline the process for the novice web-creator.

### CONTINUITY

This application is a non-provisional application of provisional application number 62/095,544, filed on Dec. 22, 2014, and priority is claimed thereto.

### FIELD OF THE PRESENT INVENTION

The present invention relates generally to website construction systems, and more specifically, to construction systems and methods configured to facilitate and expedite the website creation, content population, and publishing process via a streamlined, online tool.

### BACKGROUND OF THE PRESENT INVENTION

The nature of modern life involves interacting with a digital world. Businesses and individuals have a need to build websites to establish their online identities, to network with others, and to express feelings and ideas easily and effectively. Similarly, websites are critical to many companies and individuals in order to conduct commerce, ask for or offer help, or procure products and services. Unfortunately, the growing amount of data and informational channels utilized by a person or a business can be staggering, and individuals lacking the technological skills required to collect the information, develop a website, and deploy it on a 3rd party server can easily fall behind those that are more technologically adept.

There are many website builders that provide various techniques and tools to assist a user in building a website that are widely available today. However, with many of the conventional website builders, the users must still separately address the domain name registration process, including naming their site, manually collecting information, determining the appropriate hosting specifications and parameters, navigating non-intuitive technical control panels, as well as possessing a certain degree of technical knowledge in order to upload the webpages to the server. These can be daunting tasks to the novice web-builder, who is generally not trained to be a webmaster, or does not have time to learn all of the steps required to create domains, secure hosting space, and set up the appropriate name servers and DNS settings to get a website up and running

Thus, there is a need for a Website Builder/Publisher that virtually eliminates the technical skills required for an end-user to build, name, and publish a website using any of the Do-It-Yourself website builder tools in existence today. Such a Website Builder/Publisher system would preferably aggregate all the technical and procedural steps required to build a website, typically using multiple entities (domain registrar and hosting entities), into a few simple steps. The website building, domain registration, and publishing processes are housed in one application. Such an application is preferably web-based, and is accessible on a wide variety of internet-connected, browser-equipped devices.

### SUMMARY OF THE PRESENT INVENTION

The present invention is a website building and publishing system and method that enables beginners with nary any technical skills to create custom, populated, in-depth websites in under three minutes, complete with a registered domain and hosting via a computer or internet-connected device. The method of the present invention does not require the user to interface directly with a traditional domain registrar or hosting provider. In addition, the system of the present invention is an intelligent solution configured to develop one's website content from their social media channels, and to determine the best available domain name and/or domain extension to match the site content, and/or the identity of the individual/business user. Presently, the present invention facilitates the integration of media and data from the following social networks: Facebook™, Facebook™ Pages, LinkedIn™, Twitter™, YouTube™, Google+, Pintrest™, Flickr™, Vimeo™, Instagram™, SoundCloud™, Tumblr, and Bēhance™. Other social networks will be added as potential avenues for imported content as other social networks become more prominent.

With social networks providing initial data such as profile photos, cover photos, personal information, and mood and emotion reporting, the system of the present invention is able to rapidly populate a website with content immediately during construction. The system of the present invention is embodied in a web-based application that may preferably be used on any conventional internet-connected computing device such as a computer, tablet, or mobile phone. The system of the present invention preferably provides for new content on the creator's social network to be automatically synced to the created website, allowing updates such as emotional status, mood, and feeling at the present time, recent photos, updates, and other content to be conveyed to the created website when synced.

The present invention includes a feature that allows the end-user to extract information (content, photos, music, etc.) from his or her social media channels to his or her own new website in a new format. To help ensure continued fresh web content, the system of the present invention extracts current content from the social media channels on an on-going basis, enhancing Search-Engine Optimization (SEO) for the user.

Additionally, one of the common issues with the communicating in the digital space is the lack of emotion and feeling that is missing when using digital channels such as social media, texting, or posting online content. The present invention seeks to offer a unique method to portray the individual mood, emotions and/or feeling digitally, similar to as one would meet the individual in-person and perceive the emotional state by looking at the person alone. The system of the present invention provides the user the option to convey the overall feeling or emotional state of the user to the internet seamlessly by both importing emotional state data (based on status updates and emoticons) and via manual input. The system then may portray the emotional state of the user via a filter overlaid over the profile picture(s) of the user that are shown on the created website. The user preferably must enable this option manually via privacy settings.

The system of the present invention preferably provides the following features:
Providing the user the ability to choose a Personal or Business website design;
Assembling a collection of information by extracting content from existing channels such as social media, aggregators and other online repositories;
Easy, automated re-organization of the extracted information and displaying it in a new format which is responsive in design and highlights indicated featured content;
Ability of the user to edit content an/or enter new information manually, as desired;
Selection of a website template that best fits the purpose of the website and the intent of the user;
Offers mobile-ready designed templates (responsive design) which are scalable to facilitate view on screens of any size;
“Real-Time” preview technology shows the user how the final website will appear on a real device while the website is being built and/or edited prior to publishing it to the Internet;
Assigning a domain name and/or domain extension that is best titled for the content, purpose, and the identity of the user (based on internal logic/algorithm);
Offers a Domain Name spinning processes, which automatically checks the availability of a suggested domain name in real time before providing a list of available domain name suggestions to the user;
Registering the user-selected domain name with an ICANN accredited domain registrar;
Setting the Name Server(s) with the Registrar to point to the requisite hosting server;
Establishing one alias email address associated with the domain name which forwards only to a primary email account contained in the sign-up information;
Publishing the aggregated website to a pre-defined hosting server and providing the end-user access to a limited control panel in order to make future changes, as well as track website activity.
Providing the user full control over the selected domain name. However, if the user wishes to move the domain to another registrar, they would preferably pay a fee to move the domain into a separate, independent account.

The use of a permanent web address can have several advantages over an impersonal account with another company. A permanent web address helps to ensure that the individual or business maintains control of their content, such as controlling when, where, and what to share with the world via the internet. Additionally, personal, permanent web addresses allow the individual or business to add the current popular social media channels, change social media accounts, or remove channels at will, or if they become obsolete. The system of the present invention provides the user with total flexibility to define what social media channels and information may be displayed. The permanent ID (web URL) can be utilized on a business card, or for any other networking purpose. A permanent website address is much easier to remember, and allows the users their own virtual piece of the internet.

The present invention preferably facilitates these features through a rich, web-based, online application. The web-based application provides a location for a one-stop-shop website creation destination facilitated by the system of the present invention. Within the application, users may employ a wide variety of website creation tools, and may expeditiously craft a website with a wide variety of templates easily and affordably.

### BRIEF DESCRIPTION OF THE DRAWINGS

FIG. 1 shows a flow chart of the domain registration process of the present invention.

FIG. 2 depicts a flow chart of the content population from social networks process of the present invention.

FIG. 3 exhibits a flow chart detailing the steps taken by the user to create and publish a website with the system of the present invention.

FIG. 4 details the sign-up procedure of the method of the present invention.

FIG. 5 shows the back-end process steps enacted by the system of the present invention upon reaching the publication stage, after the website has been created.

FIG. 6 shows the detailed procedure that the system of the present invention executes during the publication stage.

FIG. 7 is a flow chart depicting the overall process of the Auto-Mode of the system of the present invention.

FIG. 8 displays a detailed account of the content population from social networks process, including Auto-Mode and standard, manual-mode content population.

FIG. 9 is a flow chart detailing how the system of the present invention selects and employs a template to frame the content for the user's website.

FIG. 10 details the process employed by the system of the present invention to create the dynamic dashboard within the web-based application of the present invention for each user.

FIG. 11 depicts the process employed by the system of the present invention during the creation and update processes of the ‘My Moments’ section of the created website.

FIG. 12 shows the process preferably employed by the present invention to regularly update content for the created website from the user's social media networks.

FIG. 13 exhibits an account of a portion of the Sign-up process, wherein users are suggested to add additional social networks for the create and import content stage from social media networks of which the system has confirmed the user is a member.

### DETAILED DESCRIPTION OF THE PREFERRED EMBODIMENT

The present invention is a method and system configured to expedite and simplify the website creation and hosting processes for the end user web-creator, while dynamically creating content based on the web-creator's online footprint via permitted, associated social networks. The present invention employs a web-based application (140), preferably accessible from any browser-equipped, internet-enabled device, providing a platform for the user to create, edit, and publish his or her website easily from nearly any location. An Auto-Mode of the present invention expedites website creation even further by automating the template selection and the create and import content processes of the present invention.

From the view of the end-user creating a website with the system of the present invention, the web-site building process and publication processes are very simple. Initially, a user creates a user account with his or her email, and may opt to log-in with the credentials from an approved social network. After a user account is created, a website template is selected by the user (or for the user, as detailed below), generally selected according to ‘personal’ or ‘business,’ and according to the user's preferences (10). Second, content may be added via connected social networks or manually by the user (20). Content includes text, media, links, videos, photos, and design elements. Content may also be imported from any social media fan pages or business pages that the user possesses. Next, the user selects a domain name from the system-provided set of suggested domains provide by a domain spinner, or enters one independently to search for availability (30). Finally, the user instructs the system of the present invention, via the web-based application, to publish the web-site to the internet (40).

Consequently, the application-side process of the present invention consists of four basic stages: a sign-up stage (100), a create and import content stage (110), a domain selection stage (120), and a publication stage (130). Each stage is preferably executed via the web-based application (140) of the present invention, and many of the procedure steps may be automated.

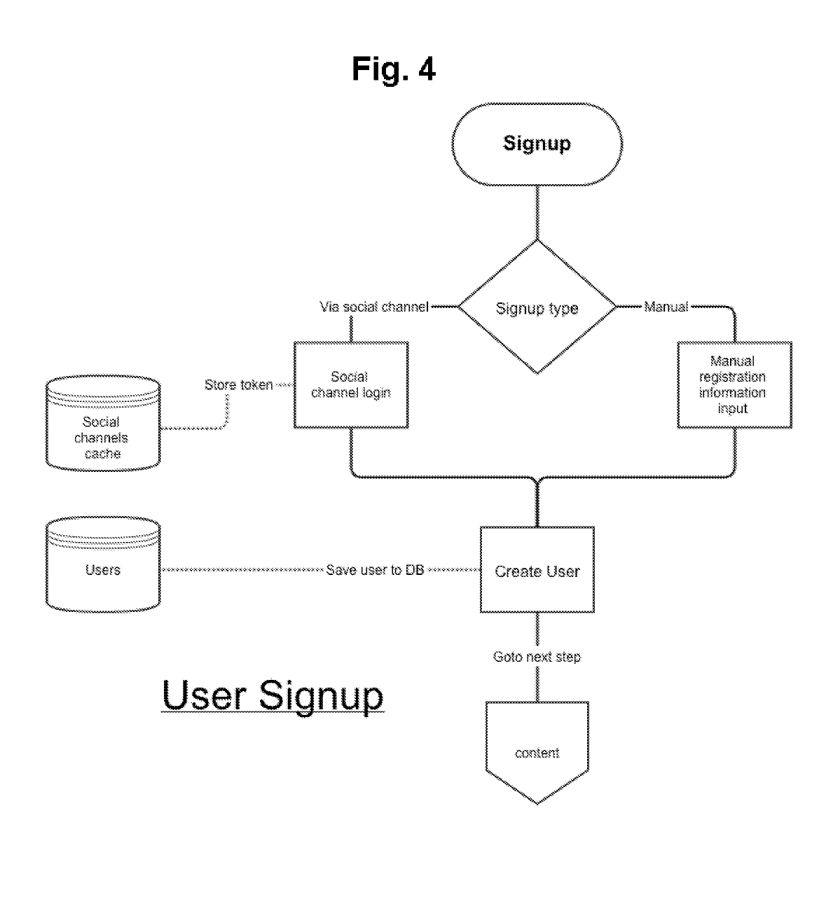

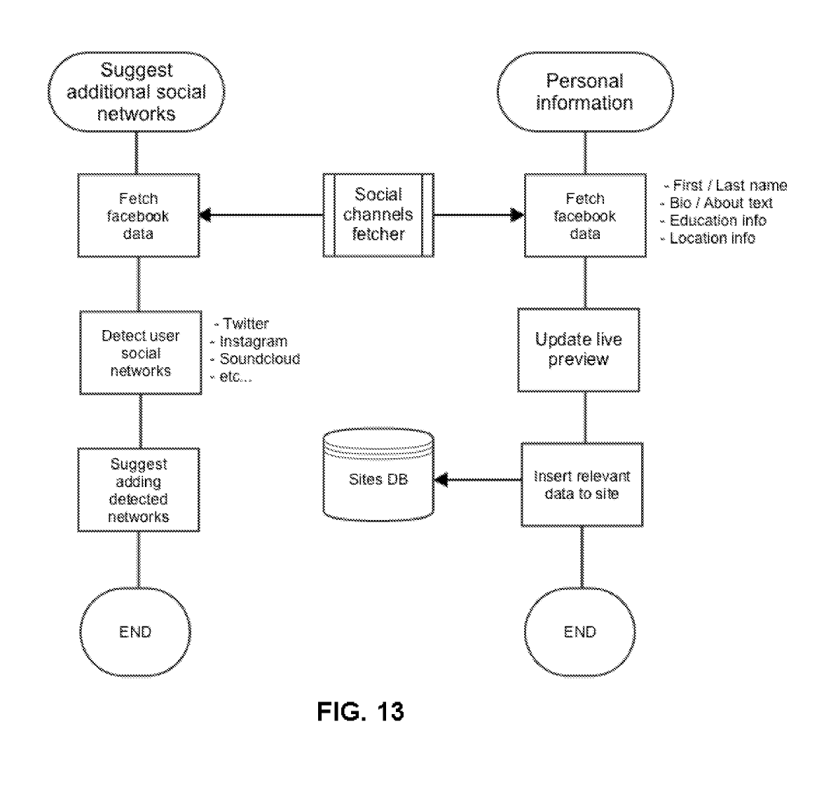

As seen in FIG. 4, during the sign-up stage (100), users may opt to sign up manually or to sign up with the log-in credentials from an approved social network site. Preferably, the user opts to log-in with his or her social network credentials, at which time a security token is stored in a social channels cache database (150) in communication with the web-application of the present invention to expedite future log-in. After a user ID is established, the user's information is securely stored within a user database. A valid e-mail address is preferably required for use of the web-based application (140) of the present invention. Users may be asked to link other social networks of which the user is a member, as shown in FIG. 13, to provide additional content and information.

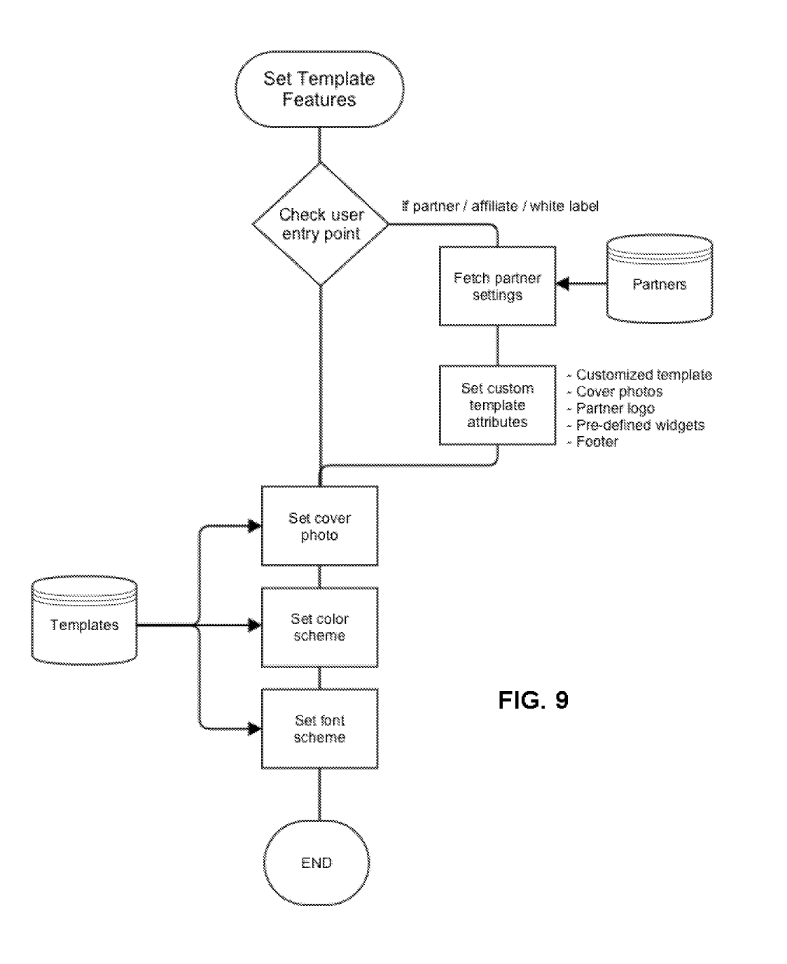

The user is then prompted to select a template from a set of pre-made templates. Templates may be supplied by partners, affiliates, or other special entities that prefer to provide corporate logos, coloring, or other template features to eligible users. The template may always be changed later at-will if the user is not satisfied, or wishes to alter the appearance of the site at a later time, with ease. In alternate embodiments of the present invention, template selection may be performed automatically to expedite website creation and publication. The template selection process and the establishment of template features performed by the system of the present invention are best seen in FIG. 9. Upon login, the system of the present invention checks to determine if the user is a member of an established partner corporation, entity, or affiliate, as some partner organizations may provide specific settings and template parameters, including custom color, customized cover photos, a partner logo, pre-defined widgets, and a pre-made footer. A specific font scheme and color scheme are also applied prior to the create and import content stage (110) of the present invention.

Thus, it should be understood that the act of selecting a template automatically for the user in Auto-Mode is preferably enacted by the system of the present invention executed on a computer by the following criteria (one or in combination):
1. Referring Affiliate (a parameter passed from an affiliated website)
2. One or more search Keywords entered by the user (captured from the search engine)
3. Based on the user's IP/Location.
4. If none of the above points to a pre-defined template, the system of the present invention preferably selects a template randomly.

Referring to FIG. 9, the process of establishing the user's template and template parameters according to their partner or affiliate status is best defined as follows:

The system of the present invention determines if the user is arriving to the web-based application (140) from an affiliated website, as the user is identified by the parameter passing through (i.e. ?partner=‘partner-name’). The system of the present invention checks for the value passing in the ‘partner’ parameter. If the value is not null, then the system will lookup the Partner's table that will identify the desired template, cover photo(s), content, logo, sponsorship information and other contextual information. If the Partner Value is Null or not found in the Partner's Table of the database, the system proceeds with standard user template customization, as seen in FIG. 9. It should be noted that the affiliate or partner user also change the pre-populated content and design of the template as he or she wishes with the exception of the partner logo and Sponsorship information on footer. Affiliates are preferably identified via an affiliate identification code. It should be understood that the affiliate identification process is merely an optional process

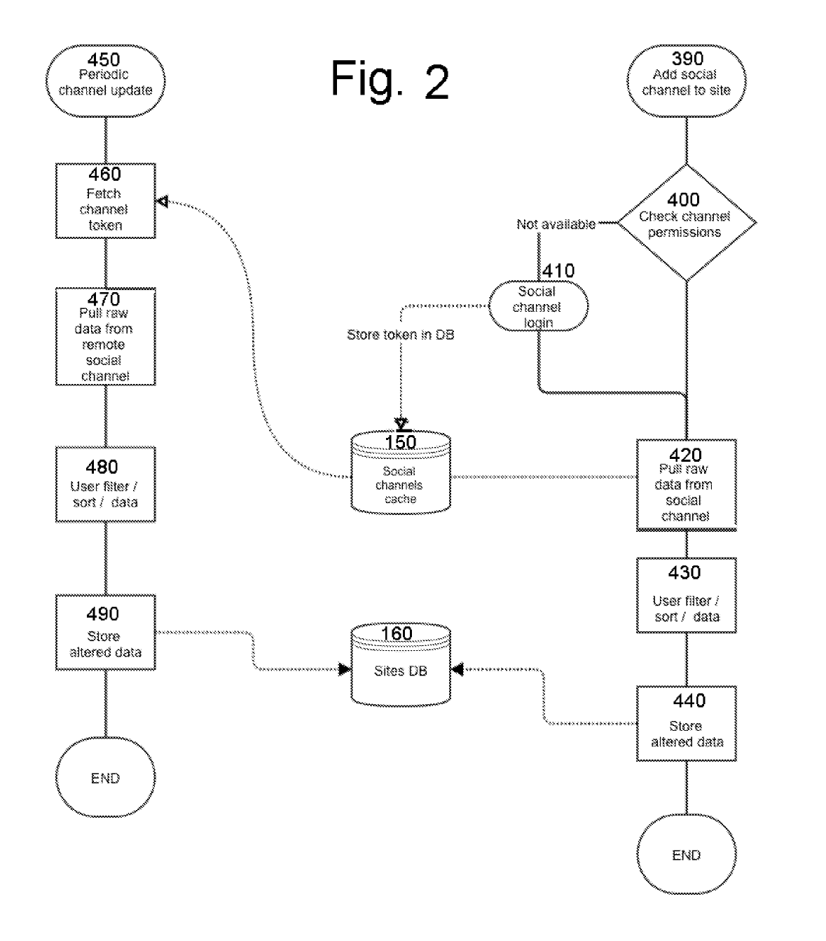

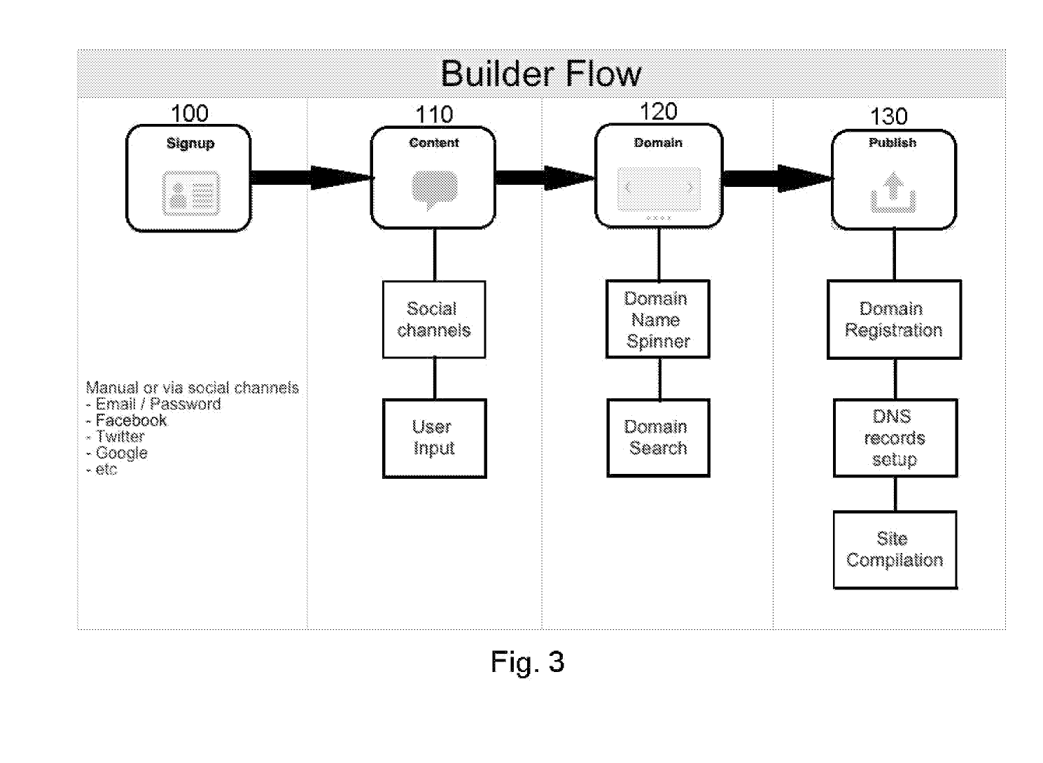

During the create and import content stage (110), users are provided the option to add social content, as shown in FIG. 2 and FIG. 3. Social content may be added from any of the available social networks which presently include Facebook™, Facebook™ Pages, LinkedIn™, Twitter™, YouTube™, Google+™, Pinterest™, Flickr™, Vimeo™, SoundCloud™, Tumblr™, and Bēhance™. First, a user selects to add a social channel to the site. (390) The present invention then checks the channel's permissions to determine if login is necessary. (400) Upon selecting one of the social networks via the icon pertaining to the social network, the user will be prompted to log-in to the specified social network with the log-in credentials of the selected social network. (410) This may not be necessary if the social network was used to sign up for an account with the web-based application, as the security token can be accessed from the social channels cache database (150) in communication with the web-based application. The system then pulls raw data from the accessible social channel (420). The data includes photos, video, text entries, affiliations, personal contact information, posts, and preferences. The user may then filter and sort the data he or she wishes to include on the website. (430) The user clicks on or selects content to be displayed, ensuring content undesirable to import remains unselected. The user is also provided the option of adding content direction from his or her internet-enabled device. The user may also opt to only display images from his or her internet-connected device, and opt to not display any social media feeds. Data is preferably stored in the website database (160) to be accessible online. (440)

The next stage of the method and system of the present invention is the domain selection stage (120). The system of the present invention includes an integrated domain ‘spinner’ (generator) which employs a computer algorithm to determine relevant top-level domains (TLDs) and relevant second level domains (SLDs) that are applicable to the user based on the user's name and content found on the newly created site, as well as based on content from any and all connected social channels. The domain spinner relies on the availability of the newly created domain extensions referred to as generic top-level domains (gTLD). As there are significantly fewer registered domains under these new gTLDs, it is readily easier for the domain spinner to search for contextually relevant, available domains that directly pertain to the user.

As the system of the present invention is in possession of a sizable portion of personal data via the website construction and create and import content stage (110), it may quickly provide suggestions to the user, expediting the site creation and publication process. Therefore, the intelligent domain spinner will generate a series of domain name suggestions based on some or all of the following parameters: the individual or entity name, the content of the website, the industry or community of the user, the personal preferences of the user, the geographic location of the user, and the language of the user.

The domain name spinner or generator bases domain suggestions on the following criterion present in the content uploaded to the database of the system of the present invention:
1. First name and/or last name (for personal websites).
2. Business name, business industry, business location (for business websites).
3. Content base search—from free text box and specific key words, scan biography and CV content.
4. Social media widgets search—for instance—job description at LinkedIn (Personal and business).
5. Registrant Address, City, Country.
6. User input: “enter key words” the algorithm offers you synonyms words, similar, related domains.
7. Custom—edit prefix and/or suffix.

For example, if the system of the present invention knew that the user's name was “John Smith,” who is an artist, lives in New York, speaks English, and likes to collect cars, the domain spinner would likely suggest domains such as: JohnSmith.NYC, JSmith.ART, or JSmith.CARS. However, if the user was from a different location, such as Argentina, it would provide suggestions of domains specific to that region, such as JohnSmith.UNO. Potential domain suggestions provide by the domain spinner are queried against a conventional whois query source, such as “http://whois.nic.uno,” to confirm the availability of potential domains prior to suggesting them to the user. The queries are preferably performed individually for each suggested domain in real-time. Suggested domains are provided to the user after confirming their availability, ensuring that the user legitimately has the capacity to acquire the suggested domain if the user chooses.

Each domain name suggested to the user by the domain spinner within the domain selection stage (120) of the system of the present invention preferably includes either the first or last name of the user. It is envisioned that the algorithm executed to provide the suggested domain names may be configured to employ other criteria such as company names, location, category, and other data to generate domain names to query for availability prior to suggesting them to the user for selection. In the event that two users are suggested the same domain name simultaneously, the user first to publish his or her website to the Internet will secure the domain name. The user that did not get the selected domain name due to recent unavailability of the domain name will be notified with a ‘domain unavailable’ message, indicating that the user must select a new domain. Subsequently, the user is presented with a new list of suggested domain names from the domain spinner. The user is provided the option to add numerals or letters before or after their name within their customized domain, helping to make the domain more unique. Each user is unable to publish a website until a domain name is available, selected by the user, and registered with ICANN via the system of the present invention.

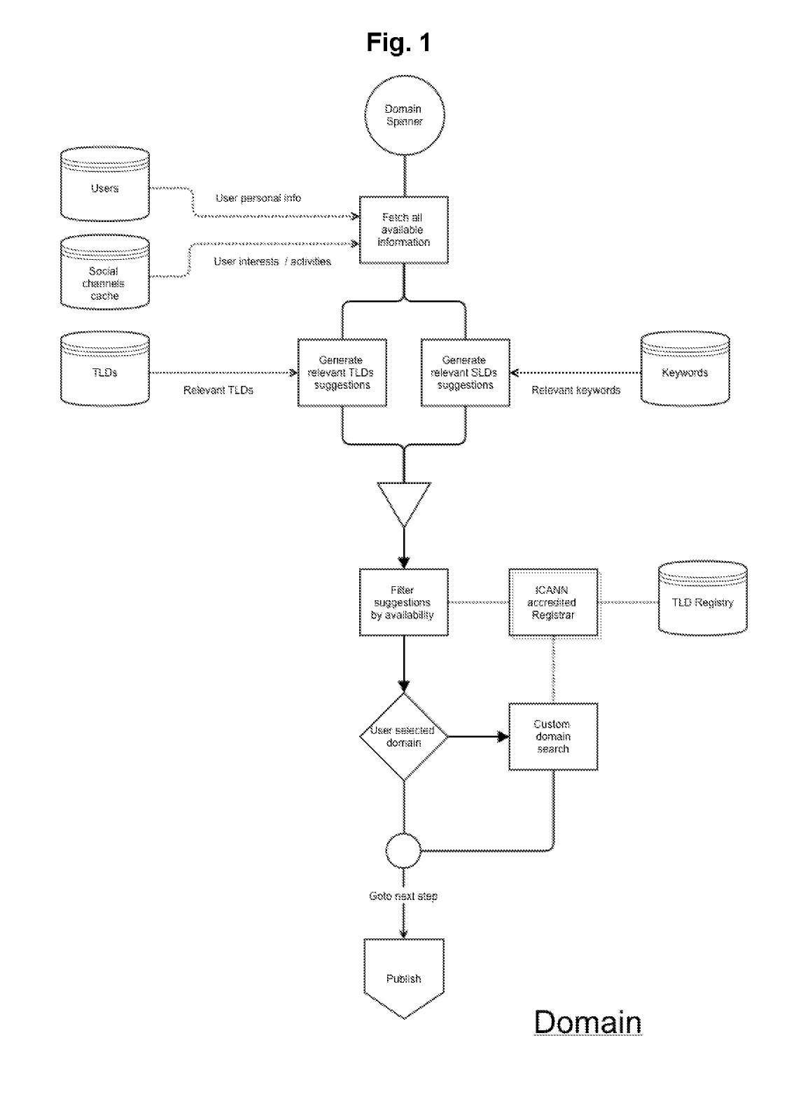

As shown in FIG. 1, the domain spinner of the system of the present invention provides the domain name suggestions to the user as a result of a domain search process which is outlined as follows:

First the system will fetch all available information, including, but not limited to the user's personal information stored in the users database, and data pertaining to the user's interests and activities, retrieved from the social channels database. (450)

Next, TLDs and SLDs suggestions will be generated based on relevant keywords found within the available information. (460) The algorithm employed by the present invention pulls key characteristics based on the user's social media information, feeds, name, and other data. The suggestions are then checked for availability against a conventional WhoIs query site, and unavailable domains are filtered out from the suggested domain list, leaving only available domains to be displayed to the user. (470) If an available suggested domain is selected by the user, the domain progresses to an ICANN accredited registrar for registration. (480) After approval, the user-selected domain is added to the TLD registry. (490) If the user does not approve of any suggested domains, he may opt to manually input a user-selected domain into a text field within the web-based application. (500) A custom domain search is performed. (510) If the domain is available, the domain progresses to an ICANN accredited registrar for registration. (480) Upon approval, the domain is added to the TLD registry. (490) The user then progresses to the publication stage for website publication. (520)

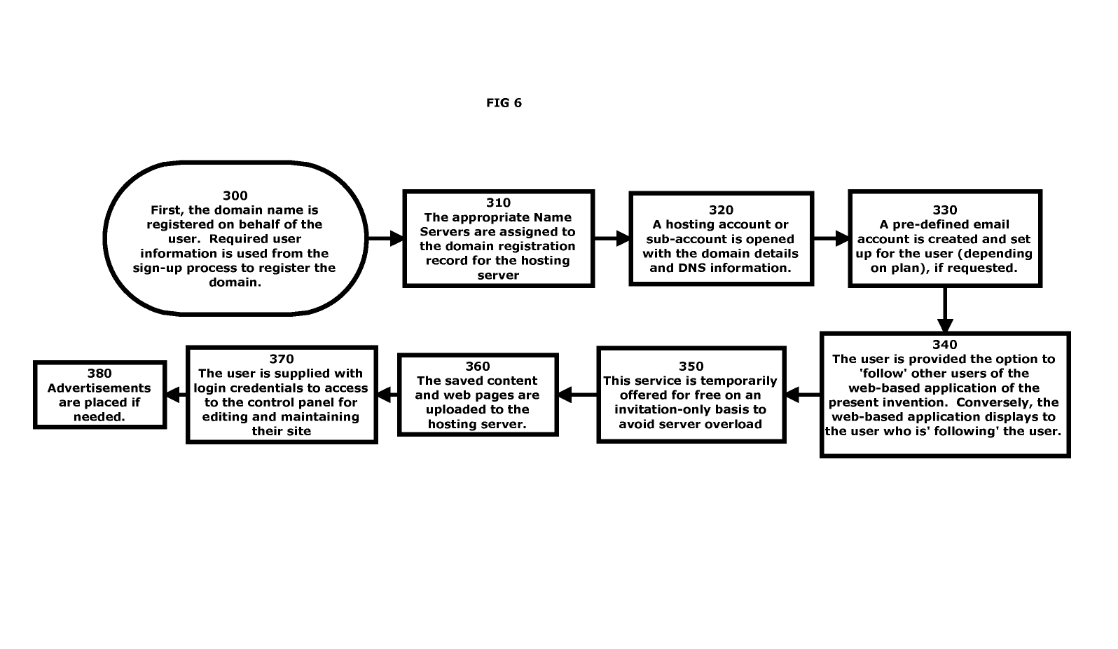

At the publication stage (130), as shown in detail in FIG. 6, the system of the present invention performs the following steps:
1. First, the domain name is registered on behalf of the user. Required user information is used from the sign-up process to register the domain. (300)
2. The appropriate Name Servers are assigned to the domain registration record for the hosting server (310)
3. A hosting account or sub-account is opened with the domain details and DNS information.

(320)
4. A pre-defined email account is created and set up for the user (depending on plan), if requested. (330)
5. The user is provided the option to ‘follow’ other users of the web-based application of the present invention. Conversely, the web-based application displays to the user which other users are ‘following’ the user. (340) The identities of those (other users) that follow the user may be displayed by name, number or thumbnail image.
6. This service is temporarily offered for free on an invitation-only basis to avoid server overload; (350)
7. Uploading the saved content/webpages to the hosting server. (360)
8. Supplying the user with login credentials to access to the control panel for editing and maintaining their site. (370)
9. Advertisements are placed if needed (380). The system of the present invention permits for limited sponsorship ads on Website Builder/Publisher user pages (most likely in the footer only) to offset some of the costs of providing a free service.

The publication stage (130) of the present invention is preferably completely automated by the system of the present invention, as shown in FIG. 6. The commands are executed by the programming governing the web-based application (140) of the present invention. The algorithms that determine which domains are suggested to the user upon initial website content creation function via relational keyword logic. The domain suggestion algorithm performs searches for keywords located within the content of the website, checking for related words with a conventional search engine, and then runs primary keywords through a WhoIS domain-based search tool to determine if and how the keywords may be used to form a domain name, and to check that it is vacant.

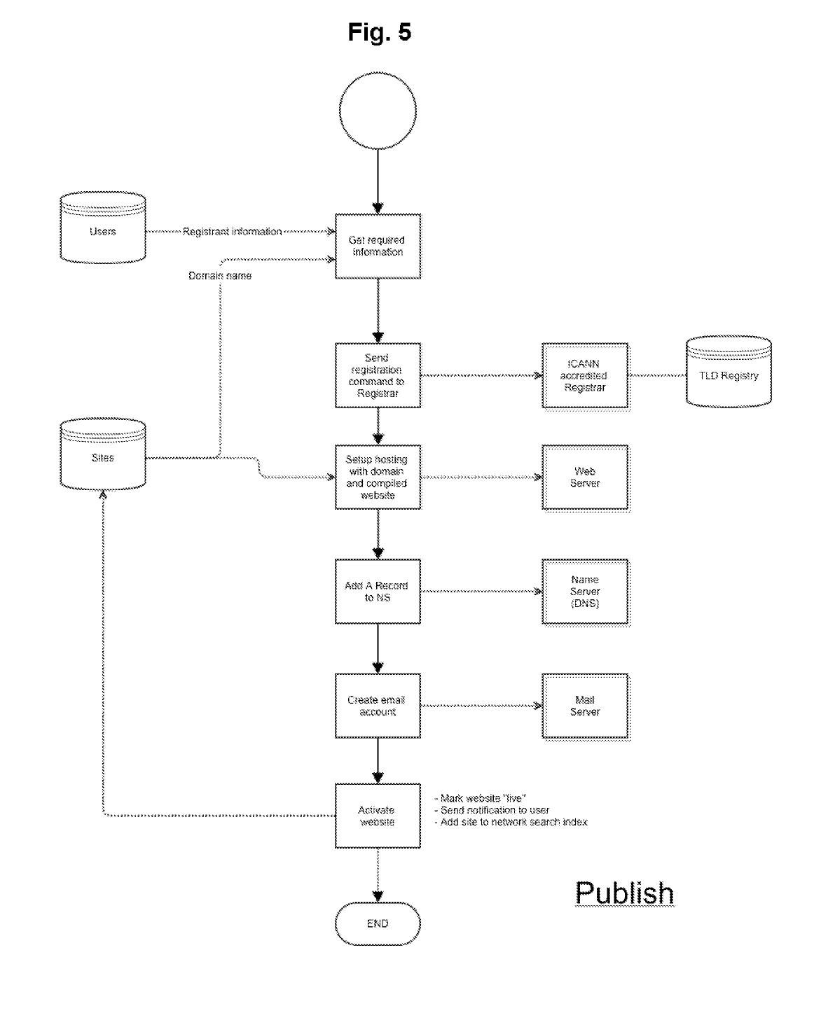

Creating, naming and publishing processes involved in website creation and publishing can be completed in less than one minute from one place via the system and web-based application (140) of the present invention, as the process is enacted via a single system, rather than multiple systems to enable website creation, content importation, suggest domains, query domain availability, register the selected domain, link the domain to the host, and publish the content. The present invention enables the end-user to visualize their website in real time throughout the entire process. Additionally, the generated website created via the method of the present invention is configured to support content in any language, including all appropriate language-specific characters. The publication stage (130), and the processes therein, are best disclosed in FIG. 5, which displays a flowchart of steps, including domain registration, leading up to the ultimate publication of the created website.

To ease compatibility across all platforms, devices, and web browsers, all embodiments of the present invention are configured to create websites that support any screen size and any resolution, making each website fully scalable, ranging from mobile screens to television and projection screens (responsive design). By default, the website created via the system of the present invention is search-engine-optimized in terms of the layout of the website, the content, and the meta tags employed in the script of the created website.

It should be understood that each user maintains full control over the content that is published to their custom generated website. The system of the present invention is configured to only pull public posts from the social media sources, as defined by the user within their respective social media account in communication with the system of the present invention. Therefore, private or privacy restricted posts are not displayed on the user's custom website generated by the present invention. By default, the generated website is preferably configured to display the ten most recent posts made by the user to social media services. Additionally, content may also be uploaded by the user directly from his or her mobile device or computer. It should also be noted that the display of the websites generated by the system of the present invention are configured to be scalable, allowing for responsive and legible website viewing on a variety of devices including cell phones, tablets, computers, and other internet connected devices.

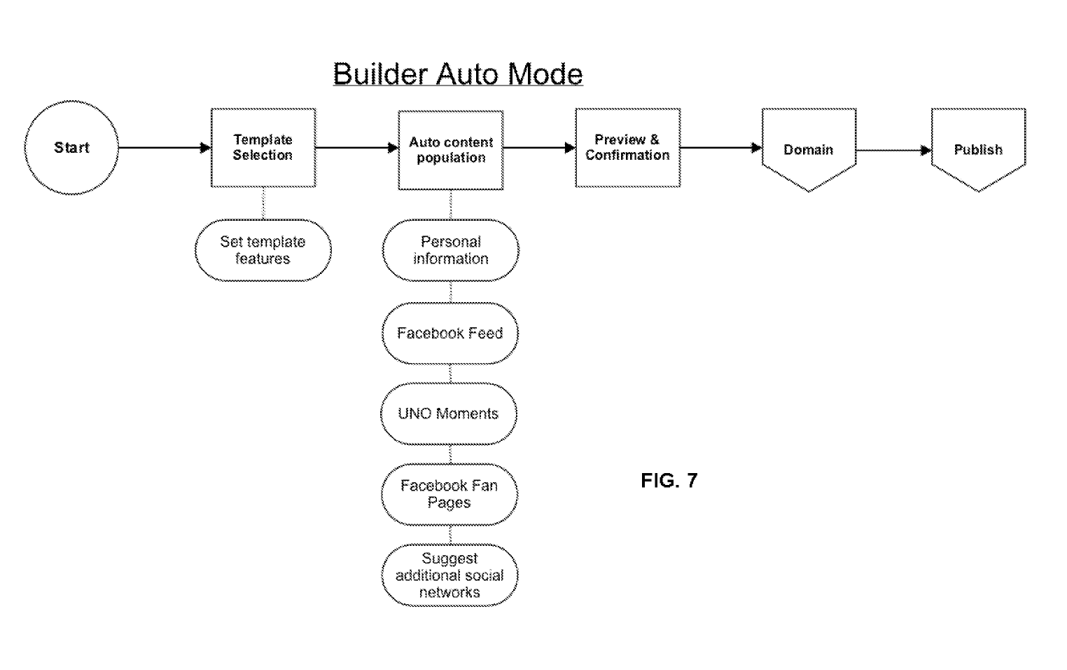

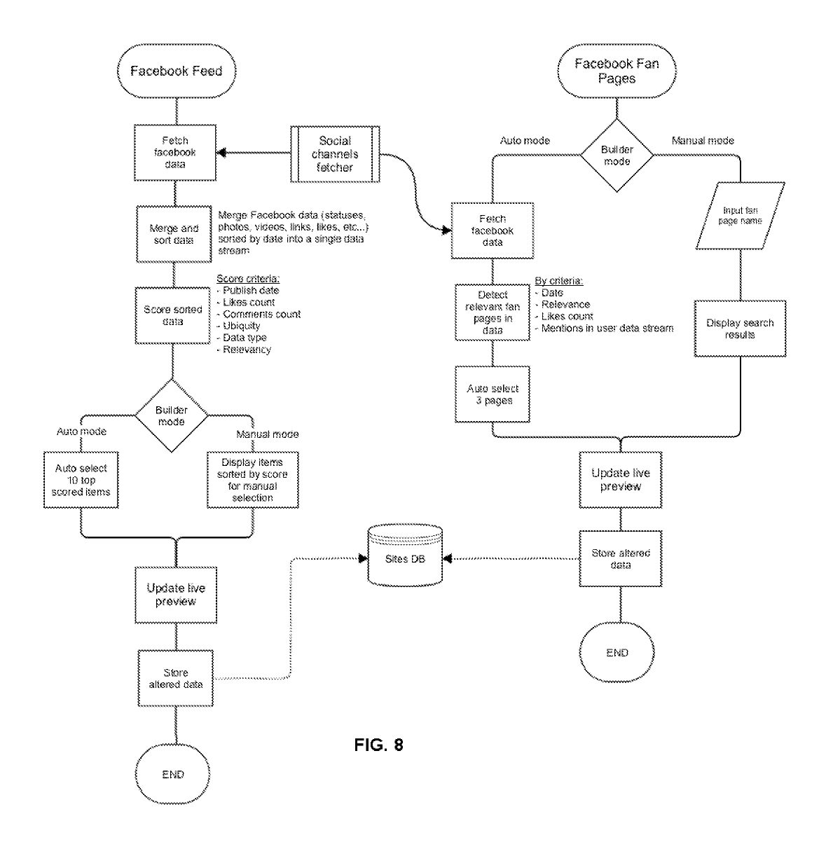

Additionally, embodiments of the present invention include a Build-it-For-Me feature, otherwise referred to as ‘Auto-Mode’, configured to automate much of the process of the system of the present invention on behalf of the user, in order to expedite the website generation process further, as shown in FIG. 7. For example, the Build-it-For-Me feature automates all of the steps required to build the social website generated by the system of the present invention by maximizing the utility of the social media content import process of the create and import content stage (110). The Build-it-For-Me feature preferably employs a generic template (including fonts, backgrounds, and colors) that is preferably custom-selected by the system of the present invention as it correlates to the preferences, content, and posts of the user from his or her social media account. Templates may be randomly generated for the user as well. Template selection is further automated in instances wherein the user is a member of an affiliate or partner group or other organization that has supplied pre-established templates and template parameters to accompany their brand, image, or marketing. The data is then organized automatically and displayed on the template in a matter of seconds.

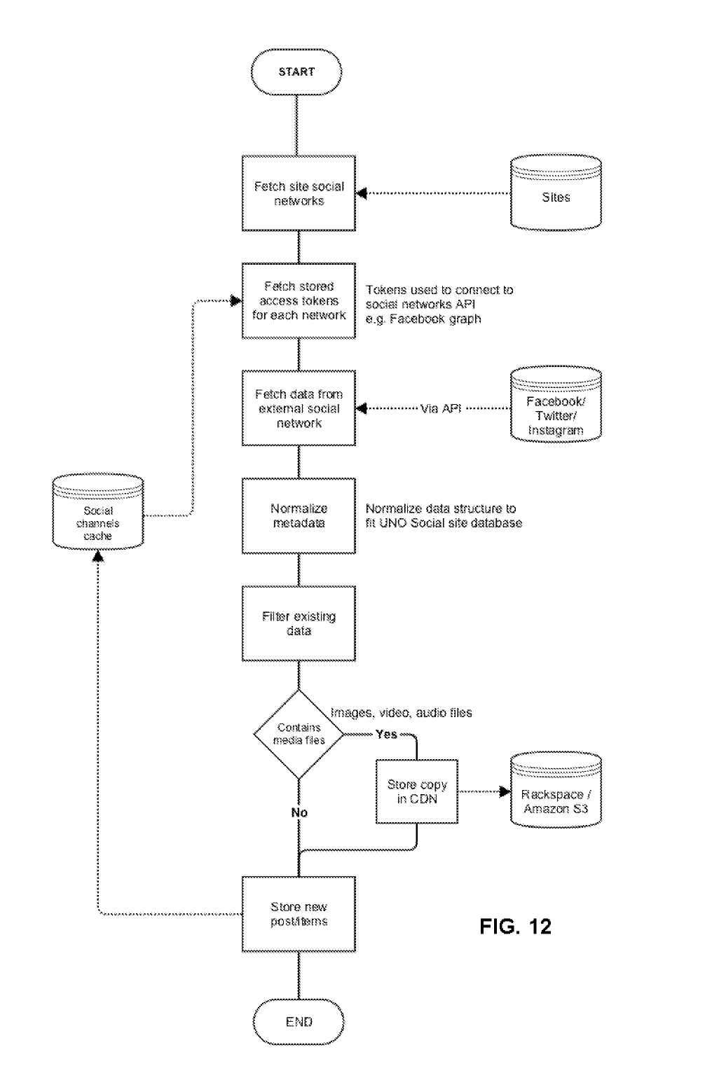

The most recent posts and photos are determined after the system of the present invention scans the social media account of the user, and content is imported. Only the ten most recent posts and photos are preferably imported to the generated website, which are displayed as content within a highlights section of the generated website. The number of recent posts imported by the present invention may be customized by the user; however, in Auto-Mode, the default value is preferably ten. Periodic updates of content are preferably enacted to ensure that the published content remains the ten, most up-to-date posts to the website, as detailed in FIG. 12. A cover photo is automatically selected for the user from the recent photos imported by the system from the social networks of the user. The cover photo may be changed by the user at any time. Subsequently, the user's content is automatically imported from alternative social media services, including, but not limited to Twitter™, Instagram™, LinkedIn™, etc. These social media accounts of the user are automatically linked, and displayed as hyperlinks to the user's social network pages under a My Social Media section of the generated website. The My Social Media section of the generated website is also preferably populated with the most recent and most viewed videos of the user's imported content automatically. The process of the present invention employs content analysis to evaluate and rank posts according to the number of views per post, as well as the number of ‘likes’ or ‘retweets’ the post receives.

Embodiments of the present invention also preferably include a ‘My Moments’ section, detailed in FIG. 11, configured to automatically post the most ‘liked’ or viewed photos and posts of the user's social media account within a default time period at regular intervals. The ‘My Moments’ section is preferably configured to automatically update the content at regular, user-established intervals. It is envisioned that, over time, the ‘My Moments’ section of the generated website will create an album of the user's most memorable moments and events over the course of his or her social media experience. For example, if a user's social media account was created 7 years ago, the system of the present invention would display the most ‘liked’ and most viewed content spanning from the most recent content back to content at the inception of the social media account. The number of ‘moments,’ or instances of content over time that are displayed may preferably be customized by the user, however the default value is 20. As with the preferred embodiment of the system of the present invention, the Build-it-For-Me or ‘Auto-Mode’ option provides the user with a preview of the website prior to publication. During the preview, the user may opt to edit, delete, or publish the website in its current form with easily accessible options provided on the screen of the user's internet-connected device.

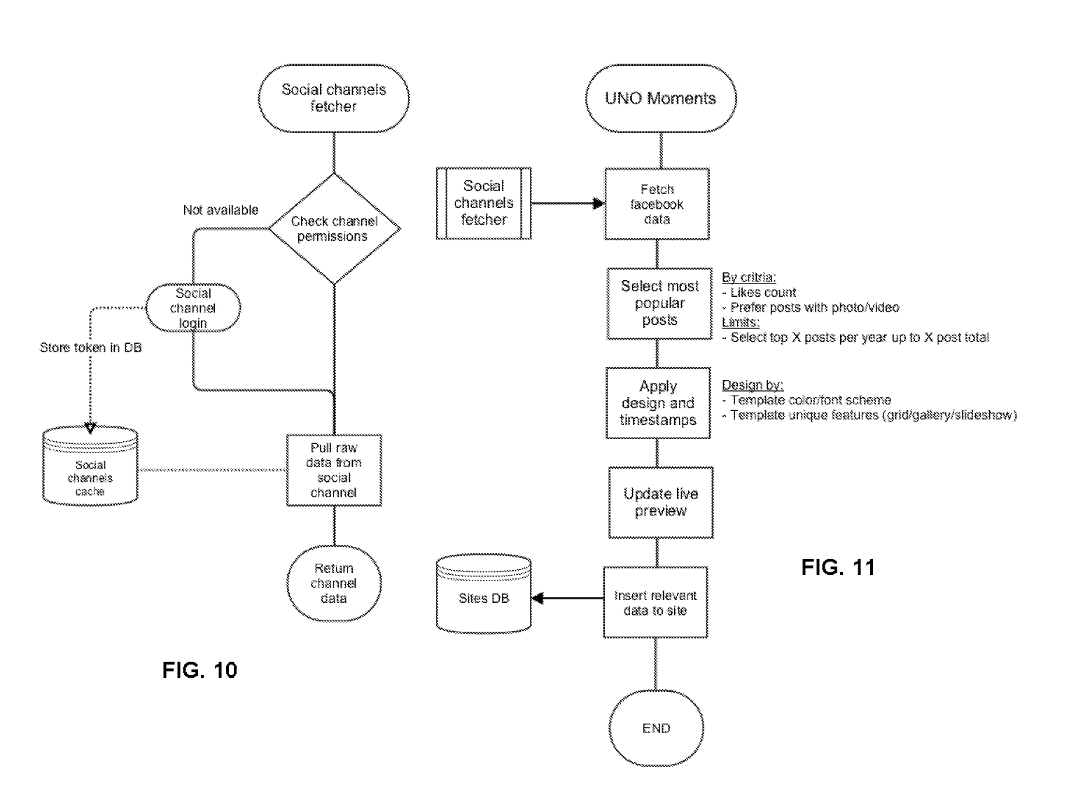

It is envisioned that each user is provided access to a user dashboard, configured to aggregate changes of other followed users' created websites. The aggregation of changes to followed users' created websites may be displayed within a single feed, notably only displaying content that is unseen to the user. The process for creating the dynamic dashboard within the web-based application (140) of the present invention is outlined in FIG. 10.

Having illustrated the present invention, it should be understood that various adjustments and versions might be implemented without venturing away from the essence of the present invention. Further, it should be understood that the present invention is not solely limited to the invention as described in the embodiments above, but further comprises any and all embodiments within the scope of this application.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

We claim:

1. A method of automatically registering and creating a website for a user on an online platform comprising:
recording the social media log-in credentials of the user in a database;
retrieving social media data pertaining to the user from at least one social network;
storing the social media data in the database;
analyzing the social media data to aggregate suggested domain name preferences of the user;
arranging the social media data in a layout on a website according to a parameter passed from an affiliated website;
presenting the user the option to select content from the social media data in the layout for display online;
populating the layout with public content from the selected social media data;
displaying the completed layout and public content of the website to the user;
presenting the user with an array of website domain name options depicting the suggested preferences of the user;
querying a WhoIs source for the availability of potential domain name suggestions;
presenting the user with available domain name suggestions based on the analyzed social media data of the user;
registering the chosen domain name;
setting DNS settings for the domain name;
hosting the website on a hosting server;
publishing the website; and
automatically updating the website with new content from social media posts at a user-defined interval, as well as portraying the emotional state of the user via a filter overlaid over a profile picture of the user based on status updates and emoticons from social media of the user.

2. (canceled)

3. The method of claim 1, further comprising uploading personal content from an internet connected device of the user to the hosting server; supplementing the displayed social media content on the website of the user with the uploaded personal content from the internet connected device of the user;
creating an email address and account directed to the domain name automatically for the user; and
linking the email address and account to an existing email address of the user.

4. The method of claim 1, wherein the social media data includes pictures, text, videos, product reviews, likes, personal identity information, gender information, and preferences.

5. The method of claim 1 wherein the online platform comprises a mobile device application and a website-generating website.

6. (canceled)

7. A method for creating a website automatically via an online platform comprising:
registering a user;
providing the user with log-in credentials to the online platform;
querying the user's active social media platforms for data and content;
importing the content to a database;
arranging the content in a layout selected by the user;
providing domain name suggestions based on the data by searching for keywords located within the content, checking for related words with a search engine, running primary keywords through a WhoIS domain-based search tool to determine if and how the keywords may be used to form a domain name, and checking that the domain name is vacant;
registering a selected domain name from the domain name suggestions with a registrar;
hosting the web site on a hosting server; and
displaying the web site to the user.

8. The method of claim 7, wherein DNS settings for the selected domain are automatically established such that appropriate Name Servers are assigned to the domain registration record for the hosting server, a hosting account/sub-account is opened with domain details and contact information, and a pre-defined email account is created and set up for the user.

9. The method of claim 7, wherein the social media content includes pictures, text, videos, product reviews, likes, personal identity information, gender information, and user preferences; and wherein the social media content is updated to the website continually throughout the lifespan of the website.

10. The method of claim 7, further comprising uploading personal content from an internet connected device of the user to the hosting server; and
supplementing the displayed social media content on the website of the user with the uploaded personal content from the internet connected device of the user.

11. The method of claim 10, wherein the online platform comprises a mobile device application and a website-generating website.

12. The method of claim 1, wherein said arranging the social media in a layout on a website is according to at least one search keyword entered by the user. (2^{nd} para, page 10)

13. The method of claim 1, wherein said arranging the social media in a layout on a website is according to an IP address of the user. (2^{nd} para, page 10)

14. The method of claim 1, wherein all steps prior to registering are performed in real-time. (lines 6-7, page 17)

15. The method of claim 1, wherein said recording, retrieving, storing, analyzing, arranging, populating, displaying, presenting, querying, presenting, registering, setting, hosting, and publishing is enacted via a single system rather than multiple systems in less than one minute.

16. The method of claim 1, wherein the affiliated website is owned by a partner organization contractually obliged to share information with affiliates.
